(19) United States
(12) Patent Application Publication
(10) Pub. No.: US 2022/0068270 A1
(43) Pub. Date: Mar. 3, 2022

(54) SPEECH SECTION DETECTION METHOD

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Seung Ho Choi, Seoul (KR); Soo Jeong An, Dong-gu (KR); Deok Gyu Yun, Seoul (KR); Han Nah Lee, Seoul (KR)

(21) Appl. No.: 17/114,942

(22) Filed: Dec. 8, 2020

(30) Foreign Application Priority Data
Aug. 25, 2020 (KR) 10-2020-0107019

(51) Int. Cl. G10L 15/20; G10L 15/02

(52) U.S. Cl. CPC G10L 15/20; G10L 15/02

(57) ABSTRACT

A speech section detection method includes: calculating a signal-to-noise ratio (SNR) value of speech data; determining whether or not to perform non-intrusive speech intelligibility estimation on the speech data based on the SNR value; calculating a speech intelligibility value of the speech data depending on a result of the determination; and detecting a speech section from the speech data based on the SNR value and the speech intelligibility value.

### CROSS-REFERENCE TO RELATED APPLICATION

This application claims the benefit under 35 USC 119(a) of Korean Patent Application No. 10-2020-0107019 filed on 25 Aug. 2020, in the Korean Intellectual Property Office, the entire disclosures of which are incorporated herein by reference for all purposes.

### TECHNICAL FIELD

The present disclosure relates to a method for detecting a speech section based on signal-to-noise ratio (SNR) and non-intrusive speech intelligibility estimation.

### BACKGROUND

Voice activity detection (VAD), also known as speech activity detection, is a technique for distinguishing speech and silence. VAD has been used in a speech recognition service, a speaker recognition service and a digital voice call service that use a speech interface.

Conventional speech section detection based on SNR estimation is a method of estimating an SNR for each frame of speech mixed with noise and detecting a speech section. As the amount of noise mixed in the speech increases, the detection method decreases in performance and thus cannot be applied to various environments.

In this regard, a method for detecting voice activity is disclosed. This method for detecting voice activity includes dividing a speech signal into a plurality of frames, converting the divided frames into frequency domains, calculating standard deviations related to spectrum energy of respective frequency bands, and if the mean of the calculated standard deviations is higher than a predetermined threshold value, determining a corresponding section as a speech section.

In the conventional method for detecting voice activity, a speech signal is divided into a plurality of frames and then converted into frequency domains and speech and non-speech sections are distinguished only based on the mean of standard deviations calculated for respective frequency bands. Therefore, exposure to various noisy environments may lead to deterioration of accuracy in detecting a speech section.

### Prior Art Document

### SUMMARY

The technologies described and recited herein include a speech section detection method capable of accurately distinguishing speech and non-speech sections even when exposed to various noisy environments.

Also, the technologies described and recited herein include a speech section detection method capable of eliminating background noise and accurately detecting a speech section and thus improving a speech recognition rate and a voice call quality in a speech recognition service, a speaker recognition service and a digital voice call service that use a speech interface.

The problems to be solved by the present disclosure are not limited to the above-described problems. There may be other problems to be solved by the present disclosure.

An aspect of the present disclosure provides a speech section detection method including: calculating a signal-to-noise ratio (SNR) value of speech data; determining whether or not to perform non-intrusive speech intelligibility estimation on the speech data based on the SNR value; calculating a speech intelligibility value of the speech data depending on a result of the determination; and detecting a speech section from the speech data based on the SNR value and the speech intelligibility value.

According to an embodiment of the present disclosure, in the calculating of the speech intelligibility value, if the SNR value is lower than a predetermined threshold value, the non-intrusive speech intelligibility estimation is performed on the speech data.

According to an embodiment of the present disclosure, in the detecting of the speech section, the speech section is detected by applying weights to the SNR value and the speech intelligibility value.

According to an embodiment of the present disclosure, in the detecting of the speech section, if the SNR value is higher than a predetermined threshold value, the speech section is detected based on the SNR value.

According to an embodiment of the present disclosure, in the calculating of the speech intelligibility value, a short-time objective intelligibility (STOI) score of the speech data is calculated through a deep neural network (DNN) for the non-intrusive speech intelligibility estimation.

The above-described embodiments are provided by way of illustration only and should not be construed as liming the present disclosure. Besides the above-described embodiments, there may be additional embodiments described in the accompanying drawings and the detailed description.

According to any one of the above-described embodiments of the present disclosure, a speech section detection method based on signal-to-noise ratio adopts a deep learning-based non-intrusive speech intelligibility estimation method that is not sensitive to various noisy environments. Therefore, it is possible to provide a speech section detection method capable of improving the accuracy in detecting a speech section.

Also, it is possible to provide a speech section detection method capable of eliminating background noise and accurately detecting a speech section and thus improving a speech recognition rate and a voice call quality in a speech recognition service, a speaker recognition service and a digital voice call service that use a speech interface.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a flowchart of a speech section detection method, in accordance with various embodiments described herein.

FIG. 2 is a depiction illustrating the configuration of a speech section detection apparatus, in accordance with various embodiments described herein.

FIG. 3 is a depiction illustrating the configuration of a non-intrusive speech intelligibility estimation unit, in accordance with various embodiments described herein.

FIG. 4A is an example depiction to explain the effect of a speech section detection method, in accordance with various embodiments described herein.

FIG. 4B is an example depiction to explain the effect of a speech section detection method, in accordance with various embodiments described herein.

### DETAILED DESCRIPTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the term “comprises or includes” and/or “comprising or including” used in the document means that one or more other components, steps, operation and/or the existence or addition of elements are not excluded from the described components, steps, operation and/or elements unless context dictates otherwise; and is not intended to preclude the possibility that one or more other features, numbers, steps, operations, components, parts, or combinations thereof may exist or may be added.

Throughout this document, the term “unit” includes a unit implemented by hardware and/or a unit implemented by software. As examples only, one unit may be implemented by two or more pieces of hardware or two or more units may be implemented by one piece of hardware.

In the present specification, some of operations or functions described as being performed by a device may be performed by a server connected to the device. Likewise, some of operations or functions described as being performed by a server may be performed by a device connected to the server.

Hereinafter, embodiments of the present disclosure will be explained in detail with reference to the accompanying drawings.

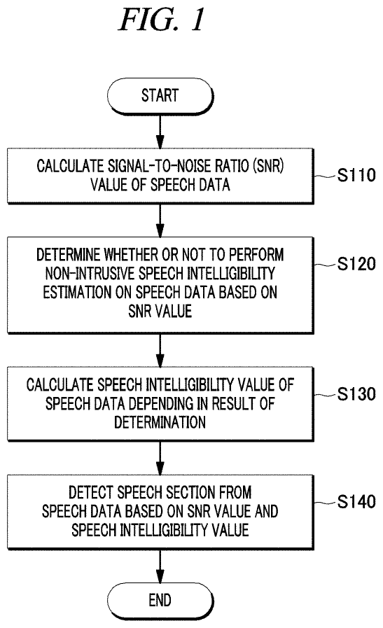

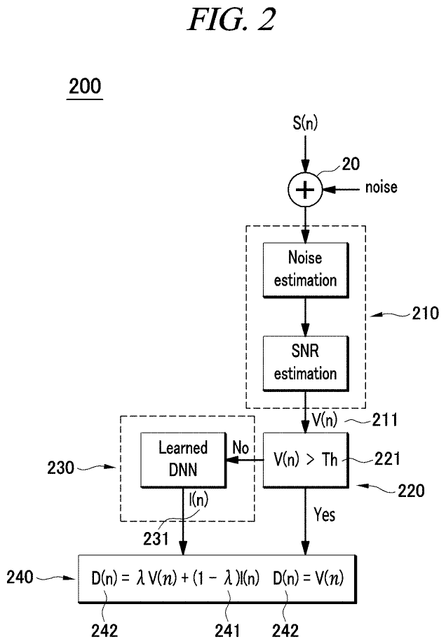

FIG. 1 is a flowchart of a speech section detection method, in accordance with various embodiments described herein, and FIG. 2 is a depiction illustrating the configuration of a speech section detection apparatus, in accordance with various embodiments described herein.

Referring to FIG. 2, a speech section detection apparatus 200 according to an embodiment of the present disclosure may include a signal-to-noise ratio estimation (SNR) unit 210, a determination unit 220, a non-intrusive speech intelligibility estimation unit 230 and a detection unit 240.

The SNR unit 210 calculates an SNR value 211 of speech data 20 and the determination unit 220 determines whether or not to perform non-intrusive speech intelligibility estimation by comparing the calculated SNR value 211 with a predetermined threshold value 221. Further, the non-intrusive speech intelligibility estimation unit 230 calculates a speech intelligibility value 231 of the speech data 20 depending on a result of the determination and the detection unit 240 detects a speech section from the speech data 20 based on the SNR value 211 and the speech intelligibility value 231.

Hereinafter, a method of detecting a speech section by distinguishing speech and non-speech sections of the speech data 20 input into the speech section detection apparatus 200 will be described by stages with reference to FIG. 1 and FIG. 2.

Referring to FIG. 1, the speech section detection apparatus may calculates an SNR value of speech data in a process S110. Here, the SNR value refers to a numerical amount of noise components contained in speech data and is defined as the ratio of signal S to noises N. The unit of the SNR value is dB, and a higher dB means less noise.

For example, referring to FIG. 2, when the speech data 20 are input into the speech section detection apparatus 200, the speech section detection apparatus 200 may divide the speech data 20 into frame units and estimate the SNR value 211 for each frame unit of the speech data 20 by means of the SNR unit 210. The SNR unit 210 may set the estimated SNR value 211 for each frame unit of the speech data 20 as a probability value between 0 and 1 and store the value (e.g., V(n), see FIG. 2).

Referring to FIG. 1, the speech section detection apparatus may determine whether or not to perform non-intrusive speech intelligibility estimation on the speech data based on the estimated SNR value for each frame unit of the speech data in a process S120.

For example, referring to FIG. 2, if the estimated SNR value 211 for each frame unit of the speech data 20 is equal to or higher than the predetermined threshold value 221, the speech section detection apparatus 200 may determine that the reliability is high by means of the determination unit 220, and a speech section can be calculated from the speech data 20 just with the SNR value 211 of a corresponding frame.

Specifically, the determination unit 220 may set the threshold value 221 for determining whether or not to perform non-intrusive speech intelligibility estimation on the speech data 20 based on the estimated SNR value 211 for each frame unit of the speech data 20 to, for example, “20”. In this case, if the estimated SNR value 211 of the speech data 20 is equal to or higher than “20”, the determination unit 220 may distinguish speech and non-speech sections in a corresponding frame of the speech data 20 just with the estimated SNR value 211 and detect a speech section. However, if the estimated SNR value 211 is equal to or lower than “20”, the determination unit 220 may not distinguish speech and non-speech sections just with the estimated SNR value 211 and may not accurately detect a speech section, and, thus, non-intrusive speech intelligibility estimation may also be performed.

That is, if the SNR value 211 estimated by the SNR unit 210 is equal to lower than the predetermined threshold value 221, it is difficult for the speech section detection apparatus 200 to accurately distinguish speech and non-speech sections just with the estimated SNR value 211, and, thus, the speech section detection apparatus 200 may also perform non-intrusive speech intelligibility estimation to more accurately detect a speech section.

Referring to FIG. 1, the speech section detection apparatus may calculate a speech intelligibility value of the speech data depending on a result of the determination in a process S130.

In the calculating of the speech intelligibility value, if the SNR value is lower than the predetermined threshold value, the non-intrusive speech intelligibility estimation may be performed on the speech data.

Referring to FIG. 2, if the SNR value 211 estimated by the SNR unit 210 is equal to or lower than the predetermined threshold value 221, the speech section detection apparatus 200 may calculates the speech intelligibility value 231 by means of the non-intrusive speech intelligibility estimation unit 230.

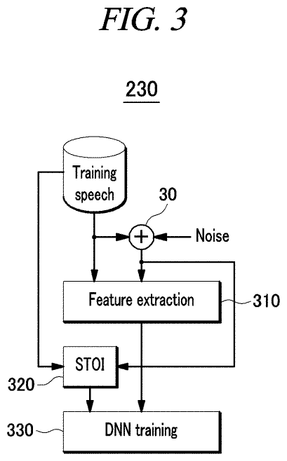

FIG. 3 is a depiction illustrating the configuration of a non-intrusive speech intelligibility estimation unit, in accordance with various embodiments described herein.

According to an embodiment of the present disclosure, in the calculating of the speech intelligibility value, a short-time objective intelligibility (STOI) score of the speech data may be calculated through a deep neural network (DNN) for non-intrusive speech intelligibility estimation and may be stored (e.g., I(n), see FIG. 2).

Specifically, referring to FIG. 3, the non-intrusive speech intelligibility estimation unit 230 may use the DNN for non-intrusive speech intelligibility estimation. The non-intrusive speech intelligibility estimation unit 230 may extract a 39^{th} feature vector from speech data 30 for training 330 the DNN. Here, the 39^{th} feature vector includes 12^{th} MFCC, log energy, delta and delta-delta.

According to an embodiment of the present disclosure, the non-intrusive speech intelligibility estimation unit 230 may use a 39^{th} feature vector 310 from the input speech data 30 and output an STOI score 320 as an output value to a single node, and, thus, the DNN can be trained 330. The DNN used in the non-intrusive speech intelligibility estimation unit 230 includes a total of three hidden layers, 1,000, 400, and 400 nodes, and may use ReLU and Softmax as activation functions.

The STOI score 320 used as an output value in the non-intrusive speech intelligibility estimation unit 230 denotes a correlation between reference speech data 30 (clean) and noise-containing speech data 30 (clean+noise), and the DNN can be trained 330 based on the STOI score 320. For example, the non-intrusive speech intelligibility estimation unit 230 may calculate STOI scores 320 of the reference speech data 30 and the noise-containing speech data 30 for each frame and train 330 the DNN based on the STOI scores 320 for each frame. Also, the non-intrusive speech intelligibility estimation unit 230 may set the STOI score 320, which is used as an output value, to a value between 0 and 1 as the standard of non-intrusive speech intelligibility estimation.

Referring to FIG. 1 again, the speech section detection apparatus may detect a speech section from the speech data based on the SNR value and the speech intelligibility value in a process S140.

In the detecting of the speech section, the speech section may be detected by applying weights to the SNR value and the speech intelligibility value.

Referring to FIG. 2 again, the speech section detection apparatus 200 may set a weight 241 based on the SNR value 211 and the speech intelligibility value 231 by means of the detection unit 240 and calculate a final value 242 for detecting a speech section from speech data by using a predetermined equation.

For example, the detection unit 240 may adaptively change the weight 241 depending on the SNR value 211 and apply different weights 241 to a non-intrusive speech intelligibility-based speech section detection model of the non-intrusive speech intelligibility estimation unit 230 and an SNR-based speech section detection model of the SNR unit 210.

Specifically, the detection unit 240 may set such that a lower weight 241 is applied when the SNR value 211 is closer to 0, i.e., the speech data 20 are exposed to more noise, and a higher weight 241 is applied when the SNR value 211 is closer to 1, i.e., the speech data 20 are exposed to less noise.

According to an embodiment of the present disclosure, the detection unit 240 may calculate the weighted means of the speech intelligibility values 231 and the speech intelligibility values 231 by using a predetermined equation. The detection unit 240 may use the following equation to calculate the weighted means.

D(n)=λV(n)+(1−λ)I(n)

Here, V(n) is the SNR value 211, I(n) is the speech intelligibility value 231, and A is the weight 241. For example, if the weight 241 is set low because the speech data 20 are exposed to much noise, the detection unit 240 may calculate the final value 242 under more influence of the speech intelligibility value 231 according to the equation.

As another example, if the weight 241 is set high because the speech data 20 are exposed to little noise, the detection unit 240 may calculate the final value 242 under more influence of the SNR value 211 according to the equation.

The final value 242 calculated by the detection unit 240 may be a probability value between 0 and 1. The detection unit 240 may set a reference value for the final value 242 calculated as a probability value between 0 and 1 and convert the final value 242 into 0 or 1 to distinguish speech and non-speech sections of the speech data 20.

Further, in the detecting of the speech section, if the SNR value 211 is higher than the predetermined threshold value 221, the speech section may be detected based on the SNR value 211.

Referring to FIG. 2, the speech section detection apparatus 200 may calculate the final value 242 for detecting a speech section from the speech data 20 based on the SNR value 211 by means of the detection unit 240. For example, the detection unit 240 may use the SNR value 211 as the final value 242 for detecting a speech section.

As described above, the final value 242, i.e., the SNR value 211, calculated by the detection unit 240 may be a probability value between 0 and 1. The detection unit 240 may convert the final value 242, i.e., the SNR value 211, which has been calculated as a probability value between 0 and 1, into 0 or 1 according to a predetermined reference value to distinguish speech and non-speech sections of the speech data 20.

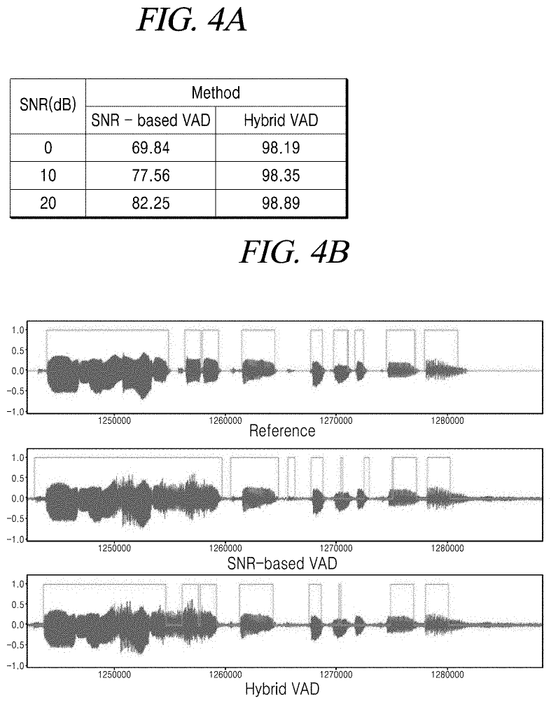

FIG. 4 is an example depiction to explain the effect of a speech section detection method, in accordance with various embodiments described herein.

The speech section detection apparatus according to the present disclosure can detect a speech section more accurately than the conventional technique according to the result of test in an SNR environment exposed to various noises. According to the conventional technique SNR-based VAD, if an SNR value is low, the performance of detecting a speech section is low. However, the speech section detection apparatus Hybrid VAD according to the present disclosure also uses a non-intrusive speech intelligibility value when an SNR value is low and thus can accurately detect a speech section.

Referring to FIG. 4A, if an SNR value is 0, the conventional technique SNR-based VAD detects a speech section only based on the SNR value with an accuracy of 69.84%, whereas the speech section detection apparatus Hybrid VAD according to the present disclosure detects a speech section based on the SNR value and a non-intrusive speech intelligibility value with an accuracy of 98.19%. If an SNR value is 10, the conventional technique SNR-based VAD detects a speech section with an accuracy of 77.56%%, whereas the speech section detection apparatus Hybrid VAD according to the present disclosure detects a speech section with an accuracy of 98.35%. If an SNR value is 20, the conventional technique SNR-based VAD detects a speech section with an accuracy of 82.25%%, whereas the speech section detection apparatus Hybrid VAD according to the present disclosure detects a speech section with an accuracy of 98.89%.

That is, the speech section detection apparatus according to the present disclosure uses a non-intrusive speech intelligibility value as well as an SNR value and thus shows an improvement in accuracy by 15% or more compared with the conventional technique. Therefore, the speech section detection apparatus according to the present disclosure detects a speech section based on an SNR value in an environment with little noise. Otherwise, the speech section detection apparatus according to the present disclosure calculates a non-intrusive speech intelligibility value and uses the non-intrusive speech intelligibility value with an SNR value to improve the accuracy in detecting a speech section.

Also, referring to FIG. 4B, in a high noise section, the speech section detection apparatus Hybrid VAD according to the present disclosure shows a speech section detection result more similar to a reference Reference than the conventional technique SNR-based VAD. Overall, the speech section detection apparatus Hybrid VAD according to the present disclosure shows a similar speech section detection result to the reference Reference.

That is, in an environment exposed to much noise, non-intrusive speech intelligibility estimation is also performed to minimize the influence of noise in detecting a speech section. For example, an AI speaker can eliminate background noise when recognizing speech and thus improve a speech recognition rate when detecting a speech section by performing intrusive speech intelligibility estimation together as in the speech section detection apparatus according to the present disclosure. As another example, the speech section detection apparatus according to the present disclosure enables a noise-free voice call.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A speech section detection method, comprising:
calculating a signal-to-noise ratio (SNR) value of speech data;
determining whether or not to perform non-intrusive speech intelligibility estimation on the speech data based on the SNR value;
calculating a speech intelligibility value of the speech data depending on a result of the determination; and
detecting a speech section from the speech data based on the SNR value and the speech intelligibility value.

2. The speech section detection method of claim 1,
wherein in the calculating of the speech intelligibility value, if the SNR value is lower than a predetermined threshold value, the non-intrusive speech intelligibility estimation is performed on the speech data.

3. The speech section detection method of claim 2,
wherein in the detecting of the speech section, the speech section is detected by applying weights to the SNR value and the speech intelligibility value.

4. The speech section detection method of claim 1,
wherein in the detecting of the speech section, if the SNR value is higher than a predetermined threshold value, the speech section is detected based on the SNR value.

5. The speech section detection method of claim 2,
wherein in the calculating of the speech intelligibility value, a short-time objective intelligibility (STOI) score of the speech data is calculated through a deep neural network (DNN) for the non-intrusive speech intelligibility estimation.
